(19) United States
(12) Patent Application Publication
(10) Pub. No.: US 2007/0047448 A1
(43) Pub. Date: Mar. 1, 2007

(54) Network equipment testing method and system

(75) Inventors: Shih-Hua Chiu, Taipei (TW); Chun-Wen Ma, Taipei (TW); Yung-Yuan Wu, Taipei (TW)

Correspondence Address: PEARL COHEN ZEDEK, LLP;PEARL COHEN ZEDEK LATZER, LLP, 1500 BROADWAY 12TH FLOOR, NEW YORK, NY, 10036, US

(73) Assignee: Inventec Corporation

(21) Appl. No.: 11/209,727

(22) Filed: Aug. 24, 2005

(51) Int. Cl. H04L 12/26; H04J 1/16

(52) U.S. Cl. 370/241

(57) ABSTRACT

A network equipment testing method and system is proposed, which is designed for use with a network system based on a server-client architecture for implementing a data transmission reliability testing procedure concurrently on one or more pieces of network equipment, and which is characterized by the utilization of a universally acceptable and recognized network testing standard for performing a data transmission reliability testing procedure. This feature allow the test results to have universal acceptance and recognition, and also allows the data transmission reliability testing procedure to be implemented with less human resource and equipment cost than the prior art, so as to allow the use of network equipment in enterprise to be more cost-effective

### BACKGROUND OF THE INVENTION

1. Field of the Invention

This invention relates to computer network technology, and more particularly, to a network equipment testing method and system which is designed for use in conjunction with a network system based on a server-client architecture for implementing a data transmission reliability testing procedure concurrently on one or more network devices, such as Ethernet adapters.

2. Description of Related Art

Enterprise-oriented network equipment, such as Ethernet adapters, typically need to undergo a data transmission reliability testing procedure before actually put into business use. In the testing procedure, each Ethernet adapter is installed to a network station to check whether it can reliably transmit and receive data packets to and from a remote station, such as a server, via network links.

Presently, it is a customary practice in the industry to utilize a specialized instrument for performing a data transmission reliability testing procedure on Ethernet adapters. One drawback to the use of this specialized testing instrument, however, is that it is highly expensive to purchase, costing typically from several hundreds of thousands to millions US dollars. Moreover, the operation of this specialized testing instrument is quite complicated so that it requires highly trained experts to operate In addition, when it is desired to test the port connectivity of multiple Ethernet adapters concurrently, it requires the purchase of additional modules which are very expensive, and the results of testing are quite unsatisfactory. Moreover, since different models of testing instruments from different manufacturers are typically equipped with testing software programs that are designed in compliance with the manufacturer's self-defined testing standards, such that the test results therefrom are typically lacking universal acceptance and recognition.

### SUMMARY OF THE INVENTION

It is therefore an objective of this invention to provide a network equipment testing method and system which can be implemented with less human resource and equipment cost than the prior art (i.e., no need to train test engineers or hire highly trained experts, and no need to purchase highly expensive testing instruments), so as to allow the use of network equipment in enterprise to be more cost effective.

It is another objective of this invention to provide a network equipment testing method and system which can perform a data transmission reliability testing procedure based on a universally acceptable and recognized testing standard so as to allow the test results to have universal acceptance and recognition around the world.

The network equipment testing method and system according to the invention is designed for use in conjunction with a network system based on a server-client architecture for implementing a data transmission reliability testing procedure concurrently on one or more network devices, such as Ethernet adapters.

The network equipment testing method according to the invention comprises: (a) on the server station, generating an amount of test packets in a predetermined quantity; (b) on the server station, transmitting the test packets in multicast via the network switch to each client station; (c) on each client station, capturing the lest packets transmitted in multicast from the server station via the network switch and received by the network device under testing; (d) on each client station, responding to the captured test packets by generating an amount of echoed test packets of the same quantity and then transmitting these echoed test packets by means of the network device under testing and via the network switch back to the server station; and (e) on the server station, comparing the quantity of the echoed test packets received via the network switch from each client station against the original quantity of the test packets previously transmitted from the server station to each client station; if the comparison is a match, capable of generating a test pass message; and if the comparison is a mismatch, capable of generating a test fail message.

In terms of architecture, the network equipment testing system according to the invention comprises: (A) a server side unit; and (B) a client side unit; wherein the server side unit is installed on the server station, and which includes: (A0) a server side network communication module, which is capable of linking the server station via the network switch to each client station for the server station to communicate with each client station via the network switch; (A1) a lest packet generating module, which is capable of generating an amount of test packets in a predetermined quantity; (A2) a multicast packet transmitting module, which is capable of transmitting the test packets generated by the test packet generating module in multicast via the network switch to each client station; and (A3) an echoed test packet quantity comparing module, which is capable of comparing the quantity of an echoed amount of test packets received via the network switch from each client station against the quality of the test packets previously generated by the test packet generating module; if the comparison is a match, capable of generating a test pass message; and if the comparison is a mismatch, capable of generating a test fail message; and wherein the client side unit is installed on each client station, and which includes: (B0) a client side network communication module, which is capable of linking the client station via the network switch to the server station for the client station to communicate with the server station via the network switch; (B1) a test packet capturing module, which is capable of capturing the test packets transmitted in multicast from the server station via the network switch and received by the network device under testing; and (B2) a packet reception responding module, which is capable of responding to the test packets captured by the test packet capturing module by generating an amount of echoed test packets of the same quantity and then activating the client side network communication module to transmit these echoed test packets by means of the network device under testing and via the network switch to the server station.

The network equipment testing method and system according to the invention is characterized by the utilization of a universally acceptable and recognized network testing standard, such as the IETF (Internet Engineering Task Force) standard, for performing a data transmission reliability testing procedure over a network system based on server-client architecture. This feature allow the lest results to have universal acceptance and recognition, and also allows the data transmission reliability testing procedure to be implemented with less human resource and equipment cost than the prior art (i.e., no need to train lest engineers or hire highly trained experts, and no need to purchase highly expensive testing instruments), so as to allow the use of network equipment in enterprise to be more cost-effective.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing a network system based on a server-client architecture on which the invention is adapted for utilization;

FIG. 2 is a schematic diagram showing the distributed system architecture of the network equipment testing system according to the invention;

FIG. 3 is a schematic diagram showing the object-oriented component model of the internal architecture of a server side unit utilized by the network equipment testing system according to the invention; and

FIG. 4 is a schematic diagram showing the object-oriented component model of the internal architecture of a client side unit utilized by the network equipment testing system according to the invention.

### DETAILED DESCRIPTION OF PREFERRED EMBODIMENTS

The network equipment testing method and system according to the invention is disclosed in full details by way of preferred embodiments in the following with reference to the accompanying drawings

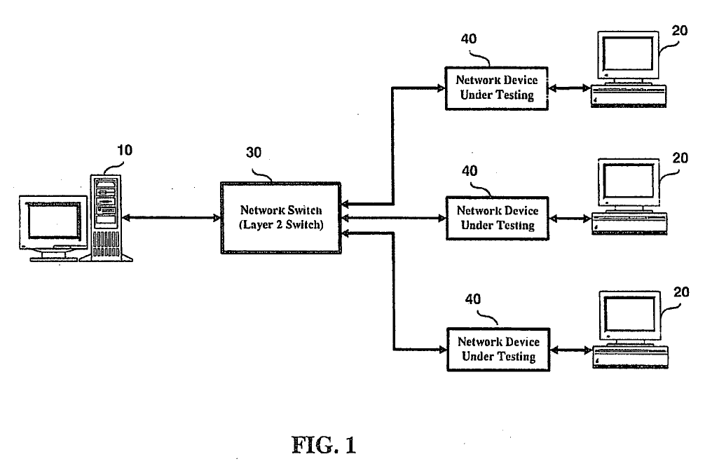

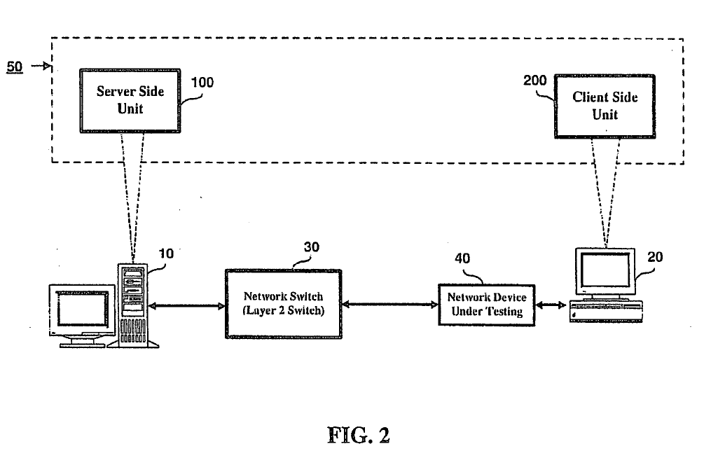

Referring to FIG. 1 together with FIG. 2, the network equipment testing system of the invention (as the part enclosed in the dotted box indicated by the reference numeral 50 in FIG. 2) is adapted for utilization with a network system that is based on a server-client architecture having a server station 10, at least one client station 20 (in the example of FIG. 1, three client stations are demonstratively shown), and a network switch 30, where the server station 10 is linked via the network switch 30 to each client station 20, and where each client station 20 is preinstalled with a network device 40 to be tested, such as an Ethernet adapter.

As shown in FIG. 2, the network equipment testing system of the invention 50 is based on a distributed system architecture, which comprises a server side unit 100 and a client side unit 200, wherein the server side unit 100 is installed on the server station 10, while the client side unit 200 is installed on each client station 20, for the purpose of performing a data transmission reliability testing procedure on the network device 40 installed on each client station 20 to see if each network device 40 is capable of reliably receiving and transmitting data packets. In the embodiment of FIG. 1, for example, three client stations 20 are shown for demonstrative purpose; and in practice, the number of client stations that the server station 10 can be linked is unrestricted, which depends on the capacity (i.e., number of connecting ports) of the network switch 30.

In practical applications, the network equipment testing system of the invention 50 has a cross-platform capability that allows the operating system of the server station 10 to be different from that of each client station 20 For example, the server station 10 can operate on Microsoft Windows NT or Server 2003 server operating system, while each client station 20 can operate on the Linux operating system. Moreover, in the best mode embodiment, the network switch 30 is preferably a “Layer 2 Switch” device, for the reason that this kind of network switch has an excellent anti-collision capability that allows the switching between the multiple client stations 20 to be more reliable and error-free.

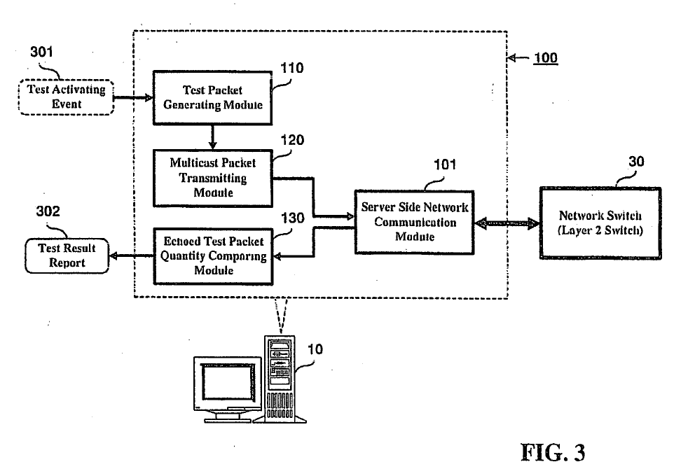

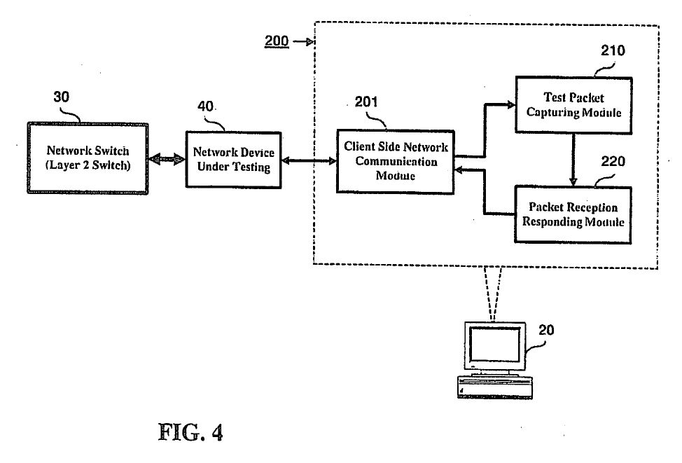

As shown in FIG. 2, the network equipment testing system of the invention 50 is based on a distributed system architecture, which comprises two distributed units: (A) a server side unit 100; and (B) a client side unit 200; wherein as shown in FIG. 3, the server side unit 100 is installed on the server station 10 and whose internal architecture includes: (A0) a server side network communication module 101; (A1) a test packet generating module 110; (A2) a multicast packet transmitting module 120; and (A3) an echoed test packet quantity comparing module 130; and wherein, as shown in FIG. 4, the client side unit 200 is installed on each client station 20 and whose internal architecture includes: (B0) a client side network communication module 201; (B1) a test packet capturing module 210; and (B2) a packet reception responding module 220.

Firstly, the respective attributes and functions of the constituent modules 101, 110, 120, 130 of the server side unit 100 installed on the server station 10 are described in details in the following

The server side network communication module 101 is installed on the server station 10, and which is capable of linking the server station 10 via the network switch 30 to each client station 20 for the server station 10 to communicate with each client station 20 via the network switch 30

The test packet generating module 110 is capable of responding to a test activating event 301 by generating an amount of test packets in a predetermined quantity. In practical implementation, for example, the test packet generating module 110 is designed in compliance with the IETF (Internet Engineering Task Force) standards for Ethernet testing, such as RFC2544 and RFC2889 to set the length of each test packet in 64, 128, 256, 512, 1024, or 1518 bits per packet. However, it is to be noted that the length of the test packet is an arbitrary design choice and has no particular restrictions; but the packet length is preferably the maximum packet length that the operating system of the server station 10 (i e., Microsoft Windows NT or Server 2003) supports. Further, a statistical research on network communication reveals that the original quantity of the test packets generated by the test packet generating module 110 should be at least 1,000 to obtain trustworthy test results about the reliability of data transmission over the network In practice, the quantity of the test packets is customarily set at about 10,000 or more.

The multicast packet transmitting module 120 is capable of transmitting the test packets generated by the test packet generating module 110 in multicast via the network switch 30 to each client station 20 In practical implementation, for example, this multicast packet transmitting module 120 utilizes a PING (Packet Internet Groper) utility and the IP address of each client station 20 to send the test packets by means of ICMP (Internet Control Message Protocol) via the network switch 30 to each client station 20.

The echoed test packet quantity comparing module 130 is capable of comparing the quantity of an echoed amount of test packets received via the network switch 30 from each client station 20 against the original quantity of the test packets previously generated by the test packet generating module 110. If the comparison is a match, it indicates that the associated network device 40 under testing is reliable in packet reception and transmission. The result is shown in a test result report 302 in the form of an electronic file. If the comparison is a match, the test result report 302 shows a test pass message; whereas if the comparison is a mismatch, the test result report 302 shows a test fail message. In practical implementation, for example, this echoed test packet quantity comparing module 130 is based on the IETF (Internet Engineering Task Force) network testing standards for Ethernet testing, such as RFC2544 and RFC1214 to determine whether the test result is a pass or a fail.

Subsequently, the respective attributes and functions of the constituent modules 201, 210, 220 of the client side unit 200 installed on each client station 20 are described in details in the following.

The client side network communication module 201 is installed on each client station 20, and which is capable of linking the associated client station 20 via the network switch 30 to the server station 10 for the client station 20 to communicate with the server station 10 via the network switch 30

The test packet capturing module 210 is capable of capturing the test packets transmitted in multicast from the server station 10 via the network switch 30 and received by the network device 40 under testing. In practical implementation, for example, this test packet capturing module 210 is a utility program in a network protocol analyzer, such as Ethereal.

The packet reception responding module 220 is capable of responding to the test packets captured by the test packet capturing module 210 by generating an amount of echoed test packets of the same quantity and then activating the client side network communication module 201 to transmit these echoed test packets by means of the network device 40 under testing and via the network switch 30 back to the server station 10. In practical implementation, if the server side unit 100 utilizes PING and ICMP to send the test packets, the packet reception responding module 220 will likewise transmit the echoed lest packets and associated control code and messages by ICMP back to the server station 10

In the following description of an example of a practical application of the invention, it is assumed that a data transmission reliability testing procedure is performed concurrently on the network devices 40 installed on the client stations 20 by using the network equipment testing system of the invention 50.

Referring to FIG. 1 through FIG. 4, in actual operation, the user (i.e., the testing engineer) needs to use the server station 10 to initiate a test activating event 301, whereby the test packet generating module 110 in the server side unit 100 of the network equipment testing system of the invention 50 is activated to generate an amount of test packets in a predetermined quantity, such as 10,000 Subsequently, the multicast packet transmitting module 120 is activated to utilize a PING utility and the ICMP network communication protocol to transmit these test packets in multicast by means of the server side network communication module 101 and via the network switch 30 to each of the client stations 20.

On each client station 20, the client side network communication module 201 in the client side unit 200 installed on the client station 20 will receive the test packets transmitted from the server side unit 100 via the network switch 30 and the network device 40 under testing. The received test packets will be captured by the test packet capturing module 210; and then the packet reception responding module 220 will respond to these captured test packets by generating an amount of echoed test packets of the same quantity and then activating the client side network communication module 201 to transmit these echoed test packets by using the ICMP network communication protocol and via the network device 40 under testing and the network switch 30 back to the server station 10

Subsequently on the server station 10, the server side network communication module 101 in the server side unit 100 will receive the echoed lest packets transmitted from the client side unit 200 on each client station 20 via the network switch 30. The echoed test packets are then transferred to the echoed test packet quantity comparing module 130, where the received quantity of the echoed test packets is compared against the original quantity of the test packets previously generated by the test packet generating module 110. If the comparison is a match, it indicates that the associated network device 40 under testing is reliable in packet reception and transmission. The test result is shown in a test result report 302 in the form of an electronic file. If the comparison is a match, the test result report 302 shows a test pass message; whereas if the comparison is a mismatch, the test result report 302 shows a test fail message.

In conclusion, the invention provides a network equipment testing method and system for use with a network system based on a server-client architecture for implementing a data transmission reliability testing procedure concurrently on one or more pieces of network equipment, such as Ethernet adapters, and which is characterized by the utilization of a universally acceptable and recognized network testing standard, such as the IETF (Internet Engineering Task Force) standard, for performing a data transmission reliability testing procedure over a network system based on server-client architecture. This feature allow the test results to have universal acceptance and recognition, and also allows the data transmission reliability testing procedure to be implemented with less human resource and equipment cost than the prior art (i.e., no need to train test engineers or hire highly trained experts, and no need to purchase highly expensive testing instruments), so as to allow the use of network equipment in enterprise to be more cost-effective. The invention is therefore more advantageous to use than the prior art

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A network equipment testing method for use on a network system based on a server-client architecture having a server station, at least one client station, and a network switch, where the server station is linked via the network switch to the client station, and where each client station is preinstalled with a network device, for the purpose of performing a testing procedure on the network device;
the network equipment testing method comprising:
on the server station, generating an amount of test packets in a predetermined quantity;
on the server station, transmitting the test packets in multicast via the network switch to each client station;
on each client station, capturing the test packets transmitted in multicast from the server station via the network switch and received by the network device under testing;
on each client station, responding to the captured test packets by generating an amount of echoed test packets of the same quantity and then transmitting these echoed test packets by means of the network device under testing and via the network switch back to the server station; and
on the server station, comparing the quantity of the echoed test packets received via the network switch from each client station against the original quantity of the test packets previously transmitted from the server station to each client station; if the comparison is a match, capable of generating a test pass message; and if the comparison is a mismatch, capable of generating a test fail message

2. The network equipment testing method of claim 1, wherein the network switch is a “Layer 2 Switch” device

3. The network equipment testing method of claim 1, wherein the server station utilizes PING (Packet Internet Groper) functionality to send the test packets to each client station.

4. The network equipment testing method of claim 1, wherein the server station utilizes ICMP (Internet Control Message Protocol) to send the test packets via the network switch to each client station

5. The network equipment testing method of claim 1, wherein the server station utilizes IETF (Internet Engineering Task Force) network testing standards for the data transmission reliability testing procedure.

6. A network equipment testing system for use with a network system based on a server-client architecture having a server station, at least one client station, and a network switch, where the server station is linked via the network switch to the client station, and where each client station is preinstalled with a network device, for the purpose of performing a testing procedure on the network device;
the network equipment testing system comprising a server side unit and a client side unit;
wherein
the server side unit is installed on the server station, and which includes:
a server side network communication module, which is capable of linking the server station via the network switch to each client station for the server station to communicate with each client station via the network switch;
a test packet generating module, which is capable of generating an amount of test packets in a predetermined quantity;
a multicast packet transmitting module, which is capable of transmitting the test packets generated by the test packet generating module in multicast via the network switch to each client station; and
an echoed test packet quantity comparing module, which is capable of comparing the quantity of an echoed amount of test packets received via the network switch from each client station against the quality of the test packets previously generated by the test packet generating module; if the comparison is a match, capable of generating a test pass message; and it the comparison is a mismatch, capable of generating a test fail message;
and wherein
the client side unit is installed on each client station, and which includes:
a client side network communication module, which is capable of linking the client station via the network switch to the server station for the client station to communicate with the server station via the network switch;
a test packet capturing module, which is capable of capturing the test packets transmitted in multicast from the server station via the network switch and received by the network device under testing; and
a packet reception responding module, which is capable of responding to the test packets captured by the test packet capturing module by generating an amount of echoed test packets of the same quantity and then activating the client side network communication module to transmit these echoed test packets by means of the network device under testing and via the network switch to the server station.

7. The network equipment testing system of claim 6, wherein the network switch is a “Layer 2 Switch” device.

8. The network equipment testing system of claim 6, wherein the multicast packet transmitting module utilizes PING (Packet Internet Groper) functionality to send the test packets to each client station.

9. The network equipment testing system of claim 6, wherein the multicast packet transmitting module utilizes ICMP (Internet Control Message Protocol) to send the test packets via the network switch to each client station.

10. The network equipment testing system of claim 6, wherein the echoed test packet quantity comparing module utilizes IETF (Internet Engineering Task Force) network testing standards for the data transmission reliability testing procedure.
